(19) United States
(12) Patent Application Publication
(10) Pub. No.: US 2025/0253366 A1
(43) Pub. Date: Aug. 7, 2025

(54) Fuel Cell Electric Power System and Method Having Heat Exchanger Bypass

(71) Applicant: Caterpillar Inc., Peoria, IL (US)

(72) Inventors: Christopher D. LUSARDI, Peoria, IL (US); Paul S. WANG, Peoria, IL (US)

(73) Assignee: Caterpillar Inc., Peoria, IL (US)

(21) Appl. No.: 18/432,416

(22) Filed: Feb. 5, 2024

(51) Int. Cl. H01M 8/0432; H01M 8/04014; H01M 8/04082; H01M 8/04111; H01M 8/04119; H01M 8/04746

(52) U.S. Cl. CPC H01M 8/04373; H01M 8/04014; H01M 8/04111; H01M 8/04126; H01M 8/04201; H01M 8/04753; H01M 8/04761; H01M 2250/20

(57) ABSTRACT

An electric power system includes a fuel cell system having a fuel cell stack, and a charge air system having an air compressor and an exhaust turbine for conveying pressurized air to and receiving exhaust from the fuel cell stack. The electric power system also includes a temperature control system having a bypass conduit, and a diverter valve structured to divert pressurized intake air or exhaust around the heat exchanger in a bypass path. The strategy improves charge air system efficiency and can mitigate concerns such as turbine inlet icing when a temperature difference between a compressor outlet temperature and a turbine inlet temperature is less than a threshold temperature difference.

### FEDERALLY SPONSORED RESEARCH OR DEVELOPMENT

This invention was made with government support under contract EE0009620 awarded by the United States Department of Energy. The government has certain rights in the invention.

### TECHNICAL FIELD

The present disclosure relates generally to a fuel cell electric power system, and more particularly to bypassing a heat exchanger in a charge air system for a fuel cell.

### BACKGROUND

Fuel cell systems are in use throughout the world for electric power generation. Fuel cells all generally produce electric power by way of controlled chemical reaction of a fuel and an oxidant, typically air, to generate electric current. Fuel cells offer the promise of reduced or even potentially zero emission of certain types, notably so-called greenhouse gases.

Fuel cell applications have expanded in recent years from smaller scale power production to higher power applications for operating electric grids and heavy machinery. It has become apparent that traditional fuel cell system designs may be inadequate to provide an optimum range of power output. For example, in some instances, it may be desirable for a fuel cell in a power generation or vehicular application to provide relatively little power output, at times, but be capable of rapidly responding to larger power demands. Widely varying power output demands as well as high absolute power demands can necessitate sophisticated apparatus for rapidly and reliably adjusting a flow of fuel and oxidate reactants to a fuel cell.

Pumps, compressors, exhaust turbines, and other equipment can be used in some instances to provide flexibility in pressures and flow rates of oxidant and fuel to satisfy varying load demands as well as high absolute demands. It is known to use a compressor and coupled turbine similar to a turbocharger application used in combustion engines to provide improved efficiency in fuel cell systems. One known system employing a compressor and exhaust turbine in a fuel cell system is set forth in U.S. application Ser. No. 18/122,176 to Kruiswyk et al.

### SUMMARY

In one aspect, an electric power system includes a fuel cell system having a fuel cell stack, an intake conduit extending to the fuel cell stack, and an exhaust conduit extending from the fuel cell stack. The electric power system further includes a charge air system having an air compressor in the intake conduit, an exhaust turbine in the exhaust conduit, and a heat exchanger. The electric power system further includes a temperature control system having a bypass conduit, and a diverter valve positioned at least partially in the bypass conduit. The intake conduit, the exhaust conduit, and the heat exchanger together define an air-exhaust heat exchange path for pressurized air and exhaust through the heat exchanger. The bypass conduit is fluidly connected to at least one of the intake conduit or the exhaust conduit and defines a bypass path around the heat exchanger for one of the pressurized air or the exhaust, and the diverter valve is movable between a closed position where the bypass path is blocked, and a second position where the bypass path is opened.

In another aspect, a method of operating an electric power system includes feeding exhaust from a fuel cell through an exhaust turbine to rotate the exhaust turbine, rotating a compressor based on the rotation of the exhaust turbine to pressurize intake air for the fuel cell, and exchanging heat between the exhaust and the pressurized intake air. The method further includes opening a bypass conduit to bypass pressurized intake air or exhaust around the heat exchanger, and reducing the exchanging of heat between exhaust and the pressurized intake air based on the opening the bypass conduit.

In still another aspect, a charge air system for a fuel cell electric power system includes an intake conduit for feeding pressurized intake air from a compressor to a fuel cell stack, an exhaust conduit for feeding exhaust from the fuel cell stack to a turbine coupled to the compressor, and a bypass conduit including an inlet fluidly connected to one of the intake conduit or the exhaust conduit, and an outlet fluidly connected to one of the intake conduit or the exhaust conduit, and defining a bypass path for pressurized air or exhaust around a heat exchanger coupled between the intake conduit and the exhaust conduit. The charge air system further includes a diverter valve positioned at least partially in the bypass conduit and being movable between a closed position where the bypass path is blocked, and a second position where the bypass path is opened. The charge air system further includes a sensing mechanism structured to monitor a temperature difference between a compressor outlet temperature and a turbine inlet temperature, and a temperature control unit coupled to the sensing mechanism and in control communication with the diverter valve. The temperature control unit is structured to command adjusting the diverter valve to the second position based on the temperature difference.

### BRIEF DESCRIPTION OF DRAWINGS

FIG. 1 is a diagrammatic view of a machine, according to one embodiment;

FIG. 2 is a diagrammatic view of a fuel cell system and charge air system, according to one embodiment;

FIG. 3 is a diagrammatic view of a fuel cell system and charge air system, according to another embodiment;

FIG. 4 is a diagrammatic view of a fuel cell system and charge air system, according to yet another embodiment; and

FIG. 5 is a block diagram of methodology and logic flow, according to one embodiment.

### DETAILED DESCRIPTION

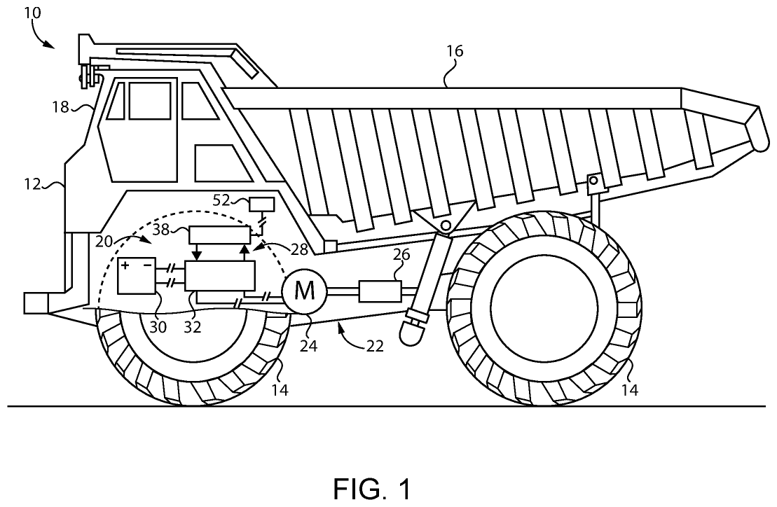

Referring to FIG. 1, there is shown a machine 10 according to one embodiment, and including a frame 12 and ground-engaging propulsion elements 14 coupled to frame 12. In the illustrated embodiment machine 10 includes a truck having a dump bed 16 and an operator cab 18. Machine 10 also includes a propulsion system 22 including, for example, an electric motor 24 and a transmission 26 structed to rotate ground-engaging elements 14. It should be appreciated that machine 10 could include a variety of different machine types including an off-highway truck, a tractor, a backhoe, a wheel loader, or any of a range of other wheeled or track-type off-highway or on-highway machines. In still other applications, machine 10 could include a stationary machine for electric power production.

Machine 10 may further include an electric power system 20 including a fuel cell system 28 having a fuel cell or fuel cell “stack” 32, a charge air system 38, a temperature control system 52, and a battery 30. Fuel cell system 28 may be configured to supply electric motor 24 with electric current to operate the same. Various other systems and subsystems onboard machine 10 may also be electrically powered, and electric power system 20 may include various electrical components for power supply, phasing, and conditioning as will be familiar to those skilled in the art. As suggested above, machine 10 and electric power system 20 could also be a stationary system for operating electrical machinery or for supplying electric power to a local or regional electric power grid.

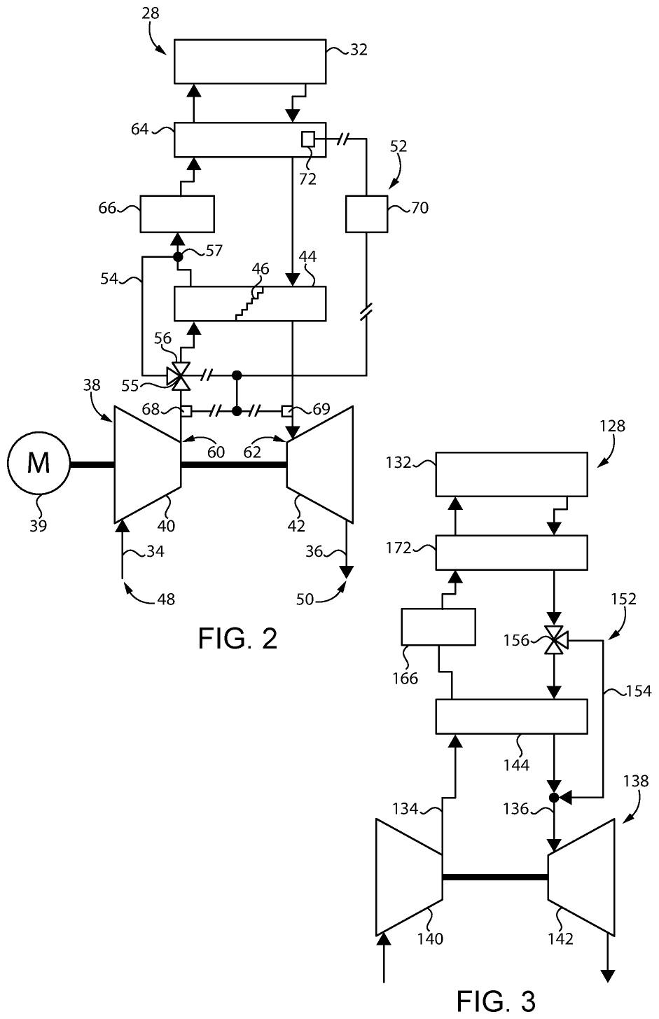

Referring also now to FIG. 2, fuel cell system 28 further includes an intake conduit 34 extending to fuel cell stack 32, and an exhaust conduit 36 extending from fuel cell stack 32. Intake conduit 34 conveys air to be pressurized from an air inlet 48 to fuel cell stack 32. The air provides a stream of oxidant to fuel cell stack 32 and a separate fuel supply (not shown) can supply fuel cell stack 32 with fuel. Exhaust conduit 36 extends from fuel cell stack 32 to an exhaust outlet 50. In a practical implementation strategy fuel cell stack 32 includes a proton exchange membrane (PEM) fuel cell stack, however, the present disclosure is not thereby limited.

Electric power system 20 also includes a charge air system 38 including an air compressor 40 in intake conduit 34 and structured to pressurize intake air to be supplied to fuel cell stack 32. Charge air system 38 further includes an exhaust turbine 42 in exhaust conduit 36 coupled to air compressor 40 and structured to be rotated by way of a flow of exhaust from fuel cell stack 32 to rotate air compressor 40. Compressor 40 and exhaust turbine 42 coupled together may comprise a turbocharger. In an embodiment, an electric motor 39 may be coupled to compressor 38 and exhaust turbine 42 to provide an electric-assist turbocharger configuration. An electric-assist turbocharger configuration may be utilized in any embodiment of the present disclosure. Charge air system 38 further includes a heat exchanger 44. Heat exchanger 44 enables exchanging heat between pressurized intake air and exhaust. In a practical implementation strategy, heat exchanger 44 includes a primary surface recuperator including heat exchange surfaces 46 exposed to flows of pressurized intake air and exhaust in a generally known manner. In other embodiments, a different heat exchanger strategy might be used. An aftercooler 66 may also be positioned in intake conduit 34 to cool pressurized intake air to be supplied to fuel cell stack 32. A humidifier 64 is also provided to humidify pressurized intake air to be supplied to fuel cell stack 32 using, for example, heat energy of exhaust.

Electric power system 20 also includes temperature control system 52 as noted above. Temperature control system 52 includes a bypass conduit 54, and a diverter valve 56 positioned at least partially in bypass conduit 54. Intake conduit 34, exhaust conduit 36, and heat exchanger 44 together define an air-exhaust heat exchange path for pressurized air and exhaust through heat exchanger 52. In an implementation, heat energy of pressurized intake air can be transferred by way of heat exchanger 44 to exhaust, enabling extraction of the additional energy via turbine 42 to pressurize additional intake air via compressor 40. Bypass conduit 54 is fluidly connected to at least one of intake conduit 34 or exhaust conduit 36 and defines a bypass path around heat exchanger 44 for one of the pressurized air for the exhaust. The bypass path may include one of an exhaust bypass path or an air bypass path. Diverter valve 56 may be movable between a closed position where the bypass path is blocked, and a second position where the bypass path is open. In some embodiments diverter valve 56 may be either fully open or fully closed, however, in some embodiments diverter valve 56 may have a range of open positions corresponding to a range of relative bypassed amounts of exhaust or air. The air-exhaust heat exchange path may remain open while the bypass path is open, such that some exhaust or air still passes through heat exchanger 44. Embodiments where the air-exhaust heat exchange path is closed when the bypass path is open are within the scope of the present disclosure.

Diverter valve 56 may be electrically actuated, hydraulically actuated, or pneumatically actuated. It will thus be appreciated that in a first operating state bypass conduit 54 is closed and a full free flow of pressurized intake air and exhaust flows through heat exchanger 44. In another operating state, bypass conduit 54 may be open by opening diverter valve 56 such that at least some of the pressurized intake air or exhaust, as further discussed herein, bypasses heat exchanger 44.

In the illustrated embodiment of FIG. 2, bypass conduit 54 fluidly connects between a location of intake conduit 34 upstream of heat exchanger 44 and a location of intake conduit 34 downstream of heat exchanger 44. As can be seen in FIG. 2, compressor 40 includes a compressor outlet 60. Bypass conduit 54 includes an inlet 55 at a location fluidly between compressor outlet 60 and heat exchanger 54, and an outlet 57 at a location fluidly between heat exchanger 44 and aftercooler 66. As suggested above, in other embodiments different configurations are contemplated.

Turning now to FIG. 3, there is shown a fuel cell system 128 according to another embodiment, and including a fuel cell stack 132. Fuel cell system 128 also includes a charge air system 138 including a compressor 140 and a turbine 142. A heat exchanger 144 is provided and may be operated analogously to the embodiment of FIG. 2. An intake conduit 134 provides a feed of pressurized intake air to fuel cell stack 132 from compressor 140, and an exhaust conduit 136 conveys exhaust from fuel cell stack 132 to turbine 142. An aftercooler is shown at 166 and a humidifier is shown at 172. Fuel cell system 128 also includes a bypass conduit 154 and a diverter valve 156, in a temperature control system 152.

Fuel cell system 128 may be closely similar to fuel cell system 28 of FIG. 2. In contrast, however, in fuel cell system 128 bypass conduit 154 fluidly connects between a location of exhaust conduit 136 upstream of heat exchanger 144 and a location of exhaust conduit 136 downstream of heat exchanger 144. It should be appreciated that the terms “upstream” and “downstream” are used herein in reference to an expected directional flow of fluids, including pressurized intake air into and through a compressor and intake conduit, then through a fuel cell stack, and exhaust into and through an exhaust conduit and a turbine. It can also be appreciated that fuel cell system 128 can be operated generally analogously to fuel cell system 28 of FIG. 2. Whereas in the embodiment of FIG. 2 pressurized intake air bypasses around heat exchanger 44, in the embodiment of FIG. 3 exhaust bypasses around heat exchanger 44. Each of the two alternative configurations can be understood to define a bypass path around a heat exchanger for one of pressurized air or exhaust, to reduce exchanging of heat between the pressurized intake air and the exhaust.

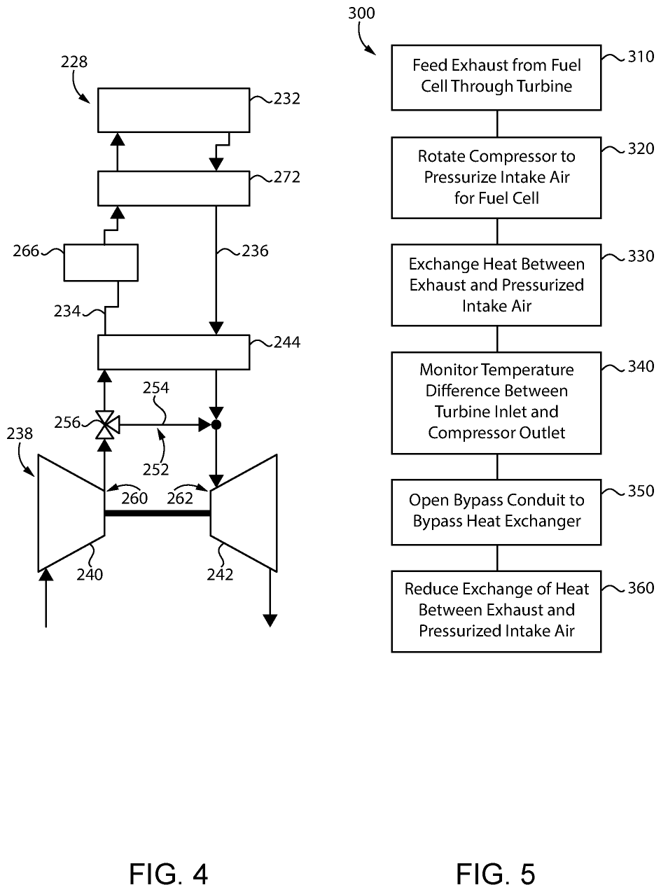

Turning now to FIG. 4, there is shown a fuel cell system 228 according to another embodiment, and including a fuel cell stack 232, an intake conduit 234 extending to fuel cell stack 232 and an exhaust conduit 236 extending from fuel cell stack 232. A humidifier is shown at 272, an aftercooler is shown at 266, and a heat exchanger is shown at 244. Fuel cell system 228 also includes a charge air system 238 having a compressor 240 and a turbine 242. Charge air system 238 also includes a temperature control system 252 having a bypass conduit 254 and a diverter valve 256. Fuel cell system 228 may be operated again similar to the foregoing embodiments, but having certain differences. Compressor 240 includes a compressor outlet 260, and turbine 252 includes a turbine inlet 262. Bypass conduit 254 fluidly connects intake conduit 234 to exhaust conduit 236. Also in the illustrated embodiment, bypass conduit 254 fluidly connects between a location of intake conduit 234 that is fluidly between compressor outlet 260 and heat exchanger 244, and a location of exhaust conduit 236 that is fluidly between a turbine inlet 262 and heat exchanger 244. It can thus be appreciated that rather than bypassing heat exchanger 244 with intake air or with exhaust and returning the bypassed intake air or exhaust to an intake conduit or an exhaust conduit, respectively, in the embodiment of FIG. 4 heat exchanger 244 is bypassed by way of feeding pressurized intake air more or less directly from compressor 240 to turbine 242 for extraction of energy of the compressed air mixed with exhaust in turbine 242 for operating compressor 240.

Returning to FIG. 2, there are shown additional features of fuel cell system 28, in particular temperature control system 52, that may be similar to features used in other embodiments. Accordingly, the present description and discussion of temperature control system 52 can be understood by way of analogy to apply to the embodiment of FIGS. 3 and 4. Temperature control system 52 includes a sensing mechanism structured to monitor a temperature difference between a compressor outlet temperature and a turbine inlet temperature. In particular, temperature control system 52 may include a compressor outlet temperature sensor 68 and a turbine inlet temperature sensor 69, electrically connected to a temperature control unit 70. A “sensing mechanism” as used herein includes one or more temperature sensors that sense temperatures of pressurized intake air and/or exhaust directly or indirectly, and including so-called virtual sensors. Temperature control system 52 may also include a humidity sensor 72 coupled to humidifier 64. With temperature control unit 70 coupled to sensors 68 and 69, and in control communication with diverter valve 56, temperature control unit 70 may be structured to command adjusting diverter valve 56 to the second position, opening bypass conduit 54, based on the monitored temperature difference. In an embodiment, diverter valve 56 is adjusted to an open position where the temperature difference is less than a threshold temperature difference. In other embodiments, a sensed humidity of pressurized intake air as indicated by humidity sensor 72 may also be considered in calculations or lookups to determine when diverter valve 56 should be opened or closed. For example, a relatively higher humidity might be indicative of a perceived increased risk of turbine inlet icing and in connection with a temperature difference or absolute temperatures justify opening diverter valve 56. Other applications considering temperature differences, absolute air or exhaust temperatures, ambient temperatures, humidity, and various other factors will be apparent to those skilled in the art.

It has been discovered that certain operating states can result in charge air system 38 being relatively less efficient, and in some circumstances even counterproductive. For example, at relatively low operating loads of fuel cell system 28, compressor 40 may be operated at a relatively low compressor speed given a relatively lower flow of exhaust. A compressor outlet temperature may, at least at times, be close to, or even below, a turbine inlet temperature. Accordingly, operation of heat exchanger 44 can result in pressurized intake air actually cooling exhaust, and reducing an amount of energy that can be extracted from the exhaust by way of turbine 42. According to the present disclosure, when a compressor outlet temperature is within a threshold temperature difference of a turbine inlet temperature, for example, diverter valve 56 can be actuated to open bypass conduit 54, therefore reducing exchanging of heat between pressurized intake air and exhaust. Generally analogous procedures can be performed in operating the embodiments of FIG. 2 and FIG. 3. The embodiment of FIG. 4 may also be operated generally analogously, except in that case the pressurized intake air from compressor 240 can be fed to turbine 242 to maintain a minimum compressor speed without increasing oxidant supply to fuel cell stack 32. As suggested above, at least in the embodiment of FIG. 4a range of open states of diverter valve 256 might be used to vary a relative amount of pressurized intake air that is bypassed around heat exchanger 244. Such a strategy may be used to maintain a compressor outlet temperature above a turbine inlet temperature or some other threshold as appropriate.

### INDUSTRIAL APPLICABILITY

Referring to the drawings generally, but also now to FIG. 5, there is shown a flowchart illustrating example methodology and logic flow according to one embodiment. At a block 310 exhaust is fed from a fuel cell or fuel cell stack through an exhaust turbine. From block 310 flowchart 300 advances to a block 320 to rotate the compressor to pressurize intake air for the fuel cell or fuel cell stack. At a block 330, heat is exchanged between the exhaust and pressurized intake air.

From block 330 flowchart 300 advances to a block 340 to monitor a temperature difference between a turbine inlet and a compressor outlet as discussed herein. From block 340 flowchart 300 advances to a block 350 to open the bypass conduit based on the temperature difference to bypass intake air or exhaust around the heat exchanger. From block 350 flowchart 300 advances to a block 360 to reduce the exchange of heat between exhaust and pressurized intake air as discussed herein.

It will be appreciated that in the case of the embodiment of FIG. 2 bypassed pressurized intake air is returned to intake conduit 34. In the case of the embodiment of FIG. 3 bypassed exhaust is returned to exhaust conduit 136. In the FIG. 4 embodiment, bypassed intake air is fed to exhaust conduit 236. As also discussed above, exchanging heat between exhaust and pressurized intake air may occur during operating a fuel cell at a higher operating load, and opening a bypass conduit may include opening the bypass conduit based on a reduction or an expected reduction to the operating load. For example, an operating load demand of a fuel cell can be monitored, and when a decrease in the demanded operating load detected the bypass conduit can be opened. In some instances, a demanded operating load may be reduced in advance of the operating load actually being reduced such as by prognosticating a future load demand based upon environmental condition. Thus, a bypass conduit can be opened in expectation of reduction in the fuel cell operating load.

A fuel cell system, a charge air system, and a temperature control system as discussed herein can all be parts of an electric power system. Moreover, for purposes of understanding the present description a temperature control system may be part of a fuel cell system or part of a charge air system, or other combinations without limitation. Any of an electric power system, a fuel cell system, a charge air system, or a temperature control system can be sold and provided as an original equipment (OEM) product or an aftermarket product including without limitation as an upgrade or retrofit.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise

What is claimed is:

1. An electric power system comprising:
a fuel cell system including a fuel cell stack, an intake conduit extending to the fuel cell stack, and an exhaust conduit extending from the fuel cell stack;
a charge air system including an air compressor in the intake conduit, an exhaust turbine in the exhaust conduit, and a heat exchanger;
a temperature control system including a bypass conduit, and a diverter valve positioned at least partially in the bypass conduit;
the intake conduit, the exhaust conduit, and the heat exchanger together defining an air-exhaust heat exchange path for pressurized air and exhaust through the heat exchanger; and
the bypass conduit being fluidly connected to at least one of the intake conduit or the exhaust conduit and defining a bypass path around the heat exchanger for one of the pressurized air or the exhaust, and the diverter valve being movable between a closed position where the bypass path is blocked, and a second position where the bypass path is open.

2. The system of claim 1 wherein the heat exchanger includes a primary surface recuperator.

3. The system of claim 1 wherein the bypass conduit fluidly connects the intake conduit to the exhaust conduit.

4. The system of claim 3 wherein the bypass conduit fluidly connects between a location of the intake conduit fluidly between a compressor outlet and the heat exchanger, and a location of the exhaust conduit fluidly between a turbine inlet and the heat exchanger.

5. The system of claim 1 wherein the bypass conduit fluidly connects between a location of the intake conduit upstream of the heat exchanger and a location of the intake conduit downstream of the heat exchanger.

6. The system of claim 5 further comprising an aftercooler, and the location of the intake conduit downstream of the heat exchanger is fluidly between the heat exchanger and the aftercooler.

7. The system of claim 1 wherein the bypass conduit fluidly connects between a location of the exhaust conduit upstream of the heat exchanger and a location of the exhaust conduit downstream of the heat exchanger.

8. The system of claim 1 further comprising an electric motor structured to rotate the compressor, and a humidifier structured to humidify pressurized intake air fed to the fuel cell stack.

9. The system of claim 1 wherein the temperature control system further includes a sensing mechanism structured to monitor a temperature difference between a compressor outlet temperature and a turbine inlet temperature.

10. The system of claim 9 wherein the temperature control system further includes a temperature control unit coupled to the sensing mechanism and in control communication with the diverter valve, and the temperature control unit being structured to command adjusting the diverter valve to the second position based on the temperature difference.

11. A method of operating an electric power system comprising:
feeding exhaust from a fuel cell through an exhaust turbine to rotate the exhaust turbine;
rotating a compressor based on the rotation of the exhaust turbine to pressurize intake air for the fuel cell;
exchanging heat between the exhaust and the pressurized intake air;
opening a bypass conduit to bypass pressurized intake air or exhaust around the heat exchanger; and
reducing the exchanging of heat between the exhaust and the pressurized intake air based on the opening the bypass conduit.

12. The method of claim 11 further comprising returning bypassed pressurized intake air or exhaust to an intake conduit or an exhaust conduit, respectively.

13. The method of claim 11 further comprising feeding bypassed pressurized intake air from an intake conduit to an exhaust conduit feeding the exhaust to the turbine.

14. The method of claim 11 wherein the opening the bypass conduit includes opening a diverter valve to open a bypass path through the bypass conduit while an air-exhaust heat exchange path through the heat exchanger remains open.

15. The method of claim 14 wherein the opening the bypass conduit includes opening the bypass conduit based on a temperature difference between a compressor outlet temperature and a turbine inlet temperature.

16. The method of claim 15 wherein the temperature difference is less than a threshold temperature difference.

17. The method of claim 14 wherein the exchanging heat between the exhaust and the pressurized intake air occurs during operating the fuel cell at a higher operating load, and the opening the bypass conduit includes opening the bypass valve based on a reduction or an expected reduction to the operating load.

18. A charge air system for a fuel cell electric power system comprising:
an intake conduit for feeding pressurized intake air from a compressor to a fuel cell stack;
an exhaust conduit for feeding exhaust from the fuel cell stack to a turbine coupled to the compressor;
a bypass conduit including an inlet fluidly connected to one of the intake conduit or the exhaust conduit, and an outlet fluidly connected to one of the intake conduit or the exhaust conduit, and defining a bypass path for pressurized air or exhaust around a heat exchanger coupled between the intake conduit and the exhaust conduit;
a diverter valve positioned at least partially in the bypass conduit and being movable between a closed position where the bypass path is blocked, and a second position where the bypass path is open;
a sensing mechanism structured to monitor a temperature difference between a compressor outlet temperature and a turbine inlet temperature; and
a temperature control unit coupled to the sensing mechanism and in control communication with the diverter valve, and the temperature control unit being structured to command adjusting the diverter valve to the second position based on the temperature difference.

19. The charge air system of claim 18 wherein the bypass path includes one of an exhaust bypass path or a pressurized air bypass path.

20. The charge air system of claim 18 wherein the bypass path directly fluidly connects the intake conduit to the exhaust conduit.
